(19) United States
(12) Patent Application Publication
(10) Pub. No.: US 2019/0331251 A1
(43) Pub. Date: Oct. 31, 2019

(54) LINEAR ACTUATOR

(71) Applicant: KANA ENERGY SERVICES, INC., Houston, TX (US)

(72) Inventors: Gary G. Taylor, Kingwood, TX (US); Terry G. Young, Longview, TX (US); Guiming Liu, Sugar Land, TX (US)

(21) Appl. No.: 16/394,968

(22) Filed: Apr. 25, 2019

Related U.S. Application Data
(60) Provisional application No. 62/662,642, filed on Apr. 25, 2018.

(51) Int. Cl. F16K 31/143; F16K 31/122; F15B 15/14

(52) U.S. Cl. CPC F16K 31/143; F16K 31/1221; F15B 2215/30; F15B 15/1428; F15B 15/1442

(57) ABSTRACT

A linear actuator comprising a housing, a top plate securable to the housing at a first end, and a bonnet securable to the housing at a second end. The housing, top plate and bonnet form a sealed cavity, a piston is biased away from the bonnet and a stem is secured to the piston, wherein the stem is axially actuated by motion of the piston and the stem passes through the bonnet to be securable to an actuated component. Further, the actuator can be disassembled and serviced while still attached to actuated equipment.

### CROSS REFERENCE TO RELATED APPLICATIONS

The current application claims priority to and the benefit of co-pending U.S. Provisional Patent Application Ser. No. 62/662,642 filed on Apr. 25, 2018, titled “LINEAR ACTUATOR”. This reference is incorporated herein by reference for all purposes in its entirety.

### FIELD

The present embodiments generally relate to a linear piston actuator mechanism.

### BACKGROUND

Linear actuators are typically used in applications where a linear displacement is required in a defined region of travel. Typical linear actuators are diaphragm actuators or piston actuators.

A linear piston actuator utilizes a piston which travels axially along the length of a cylinder. A typical use for a linear actuator in an industrial environment is for the actuation of valves. Exemplary valves used with a linear actuator are often referred to a rising stem valves, and include globe valves, ball valves, gate valves, control valves, and the like.

Actuators currently in use have several drawbacks in operation. Often several components of the actuator are exposed to atmosphere and can rust, or otherwise degrade. It is necessary to disconnect the actuator from attached equipment in order to maintain or service the actuator. Asymmetric construction often leads to uneven wear and reliability issues for many existing actuators.

The present disclosure cures the above deficiencies.

### BRIEF DESCRIPTION OF THE DRAWINGS

The detailed description will be better understood in conjunction with the accompanying drawings as follows:

FIG. 1 is a cut view of a linear actuator according to one or more embodiments.

FIG. 2 is a cut view of a linear actuator according to one or more embodiments.

The present embodiments are detailed below with reference to the listed Figures.

### DETAILED DESCRIPTION OF THE EMBODIMENTS

Before explaining the present invention in detail, it is to be understood that the invention is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only and are not intended to be limiting.

Specific structural and functional details disclosed herein are not to be interpreted as limiting, but merely as a basis of the claims and as a representative basis for teaching persons having ordinary skill in the art to variously employ the present invention. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The use of the word “a” or “an” when used in conjunction with the term “comprising” in the claims and/or the specification may mean “one,” but it is also consistent with the meaning of “one or more,” “at least one,” and “one or more than one.”

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description herein, but is only limited by the claims which follow, encompassing all equivalents of the subject matter of the claims. Each and every claim is incorporated into the specification as an embodiment of the present disclosure. Thus, the claims are a further description and are an addition to the preferred embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

The present embodiments generally relate to a linear actuator mechanism. Such actuators are typically used in industrial applications, such as to open and close valves. The present disclosure is unique in that the actuator is symmetrically constructed and protects the components from the environment. Further, the actuator can be disassembled and serviced while still attached to actuated equipment.

The present disclosure relates to a linear actuator comprising a housing having a first end and a second end, wherein the first end and the second end are open, a top plate securable to the housing at the first end, a bonnet securable to the housing at the second end, a sealed cavity formed by the housing, the top plate, and the bonnet when the top plate and bonnet are secured to the housing, a piston biased away from the bonnet, and a stem secured to the piston, wherein the stem is axially actuated by motion of the piston and the stem passes through the bonnet to be securable to an actuated component.

The bonnet can be securable to equipment comprising the actuated component and the top plate or the bonnet can be unsecured from the housing without the stem being unsecured from the actuated component.

The housing can be a symmetrical component providing an enclosure and protection for the various components of the actuator. The housing can be open on both ends and securable to a top plate and a bonnet. When viewed from one of the ends, the housing can be of any geometrical shape to enclose the components. A circular embodiment will be discussed below but is not intended to be limiting. Further, a novel feature of the housing is that it can be reversed due to the symmetry, unlike existing apparatus.

A top plate can be secured to the housing at a first open end. The top plate can incorporate various features as desired for a specific application. The top plate can have a fluid port for fluid control of the actuator by hydraulic or pneumatic means. The top plate can further have a pressure relief mechanism or other safety relief valve. In embodiments, a top shaft can pass through the top plate to allow for manual control of the linear actuator. The top plate can be secured to the housing using any known means, such as threading it to the housing, attaching it with shear rings, and the like.

A bonnet can be secured to the housing at a second open end. The bonnet can be secured to the housing using any known means, such as threading it to the housing, attaching it with shear rings, and the like. The bonnet can incorporate various features as desired for a specific application. The bonnet can have openings to allow for connection of the actuator to equipment, such as bolt holes. The bonnet can also have an opening for a stem to exit the actuator and engage a piece of equipment. The stem can be secured to a piece of equipment requiring a linear actuation, such as a valve or other piece of equipment.

When secured to the housing, the top plate and the bonnet can form a sealed compartment to protect the components of the actuator from atmospheric contaminants and degradation. In embodiments in which the top plate has a fluid inlet port, the port can be plugged, or attached to a fluid pressurization system to maintain the sealed cavity.

A piston can be secured to the stem and in mechanical communication with the housing. The piston, when actuated can move the stem in an axial direction. The piston can be actuated with fluid pressure, such by a pneumatic or hydraulic system, or manually when a top shaft is included. In embodiments, the stem and the top shaft can be a single piece with the piston secured thereto.

The piston can be biased away from the bonnet. In embodiments, the bias can be a spring in mechanical communication with the bonnet and the piston, wherein the spring biases the piston away from the bonnet. In other embodiments, a pressurized fluid can provide the bias to the piston. Any biasing means known to persons having ordinary skill in the art can be used for biasing the piston.

In embodiments, several characteristics of the disclosed embodiments can serve as a fire seal in the event that the equipment that the actuator is attached to catches fire. Potential secondary, tertiary, or quaternary seals include: a contact area of the stem and the bonnet, a seal between the stem and the bonnet, and the sealed cavity formed by the housing in conjunction with the top plate and the bonnet.

In embodiments, the top plate, the bonnet, and the housing are radially symmetrical in relation to the stem.

The symmetrical design and usage of a top plate and bonnet in conjunction with the housing allow for the actuator to be disassembled without disconnecting the stem from the equipment being actuated. The actuator can be disassembled by disconnecting either the top plate or the bonnet. The components can then be serviced and maintained without the need to remove the actuator to a repair or maintenance facility.

### Example

The following provides a detailed example of maintenance for one embodiment of the apparatus.

To maintain the actuator, the following steps can be taken:

Remove the power line to the actuator. If a compressor is used, shut it down. To remove the housing from the bonnet, take a tool (preferably sharp bladed) and remove the retainer ring from the groove. Next, the split ring can be removed. This ring can be pulled out easily. In embodiments, there are four (4) small holes located on each end of the housing. A small diameter tool can be used to push thru the holes and displace the shear ring inward thereby releasing the tension on the ring. Once, the ring is pushed in, the housing can be lifted off. Use a similar procedure to remove the top plate if desired.

The piston can remain connected to bonnet stem and loaded by a helical spring. You can leave the piston intact if the stroke has not been affected by movement of shims. Inspect stem and shims for injury.

If the actuator has been disassembled with the top plate removed from the housing, remove all o-rings and replace with new components. Clean all sealing surfaces. Use new grease for grooves. Inspect housing inner diameter for damage.

Install top plate into top of housing. Lower and align carefully. Use grease, once aligned push downward till the plate stops on shoulder of housing. Install shear ring, split ring, and retainer ring if used. Check small o-ring in neck of top plate before lowering on bonnet stem.

Lift the top plate and housing sub-assembly down and over the piston and bonnet stem. Once aligned push downward till housing stops on bonnet shoulder. Install shear ring pushing from inside out into groove. Slide split ring up and into space behind shear ring. Once seated behind shear ring install retainer ring.

The actuator is now assembled. It can be rotated for alignment and connected to a fluid line.

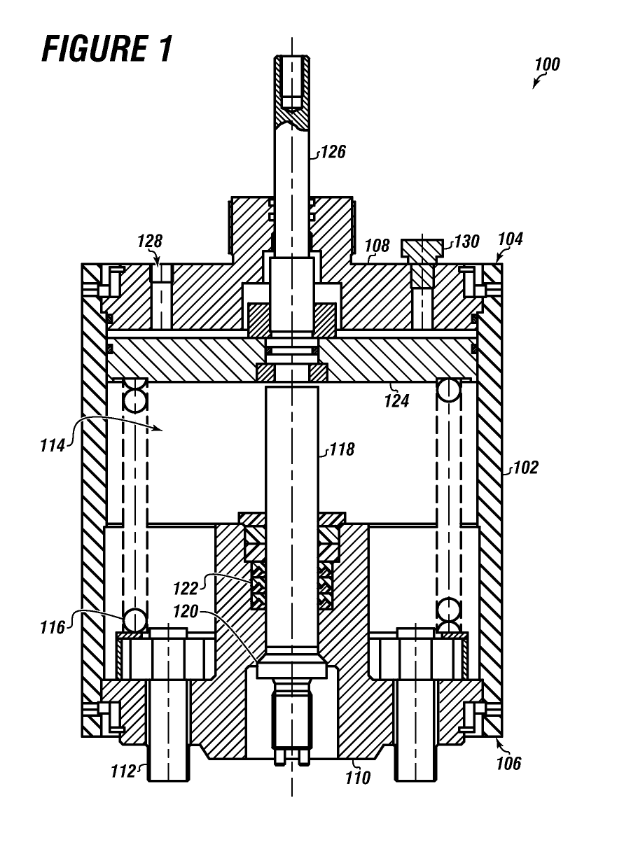

Turning now to the Figures, FIG. 1 is a cut view of a linear actuator according to one or more embodiments.

Shown is the linear actuator 100 with housing 102. The housing 102 can have a first end 104 and a second end 106 secured to a top plate 108 and a bonnet 110 respectively. While the top plate and bonnet are secured in this embodiment with shear rings and retainer rings, any connection means known to persons having ordinary skill in the art can be employed. The bonnet can be secured to equipment being actuated, such as with bolt 112.

When housing 102, top plate 108, and bonnet 110 are attached together, sealed cavity 114 can be formed. Stem 118 can move axially to actuate equipment. Contact area 120, seal 122, or the sealed cavity 114 can all serve as fire seals in the event that equipment that the actuator 100 is attached to catches fire.

Piston 124 can be secured to the stem 118 and have a bias 116 (shown here as a spring) away from the bonnet 110. In embodiments, a top shaft 126 can be provided to allow for manual control of the actuator. In embodiments, the stem 118 and the top shaft 126 can be a single piece with the piston 124 secured thereto.

The top plate can also have a fluid port 128 to allow for pneumatic or hydraulic control of the actuator. A pressure relief mechanism 130 (shown here as a burst disc) can be incorporated as a safeguard.

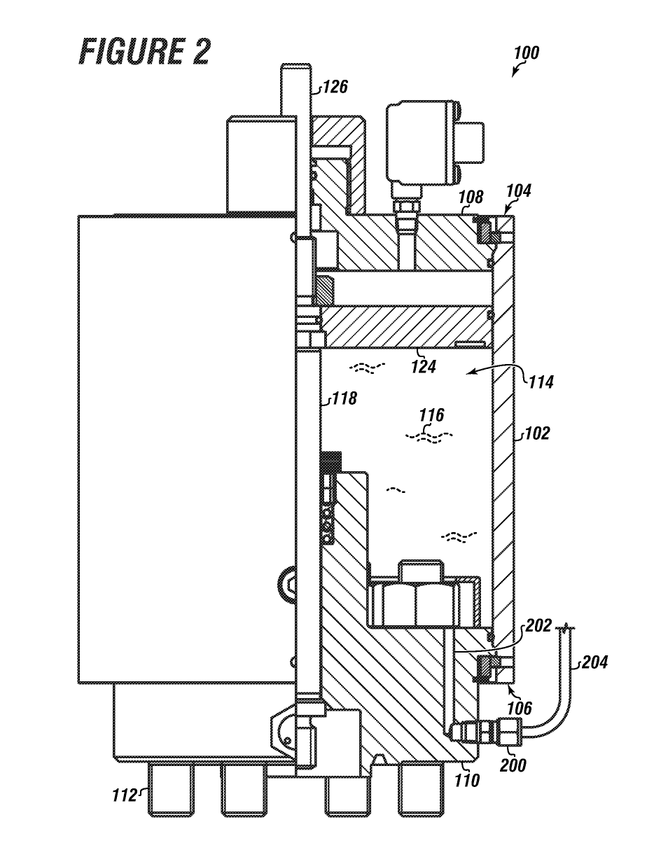

FIG. 2 is a cut view of a linear actuator according to one or more embodiments.

In this embodiment, the bonnet 110 has a port with a fluid pathway 202 to receive a fluid fitting 200 in communication with a fluid supply 204. A piston 124 can be secured to the stem 118 and have a bias 116 (shown here as a fluid) away from bonnet 110.

While the disclosure emphasizes the presented embodiments and Figures, it should be understood that within the scope of the appended claims, the disclosure may be embodied other than as specifically enabled herein.

What is claimed is:

1. A linear actuator comprising:
a) a housing having a first end and a second end, wherein the first end and the second end are open;
b) a top plate securable to the housing at the first end;
c) a bonnet securable to the housing at the second end;
d) a sealed cavity formed by the housing, the top plate, and the bonnet when the top plate and the bonnet are secured to the housing;
e) a piston biased away from the bonnet; and
f) a stem secured to the piston, wherein the stem is axially actuated by motion of the piston, and further wherein the stem passes through the bonnet to be securable to an actuated component and the bonnet is securable to equipment comprising the actuated component; and
wherein the top plate or the bonnet can be unsecured from the housing without the stem being unsecured from the actuated component.

2. The linear actuator of claim 1, further comprising a top shaft secured to the stem which passes through the top plate to allow for manual control of the linear actuator.

3. The linear actuator of claim 1, further comprising a fluid inlet port to allow fluid into the sealed cavity.

4. The linear actuator of claim 1, further comprising a spring within the sealed cavity in mechanical communication with the bonnet and the piston, wherein the spring biases the piston away from the bonnet.

5. The linear actuator of claim 1, further comprising a fluid within the sealed cavity, wherein the fluid biases the piston away from the bonnet.

6. The linear actuator of claim 1, wherein a contact area of the stem and the bonnet functions as a fire seal.

7. The linear actuator of claim 1, wherein a seal between the stem and the bonnet functions as a fire seal.

8. The linear actuator of claim 1, wherein the sealed cavity functions as a fire seal.

9. The linear actuator of claim 1, wherein the top plate, the bonnet, and the housing are radially symmetrical in relation to the stem.

10. The linear actuator of claim 2, wherein the stem and the top shaft are a single piece.

11. The linear actuator of claim 3, further comprising a pressure relief mechanism.

12. A linear actuator comprising:
a) a reversible housing having a first end and a second end, wherein the first end and the second end are open and symmetrical with respect to one another;
b) a top plate securable to the housing at the first end;
c) a bonnet securable to the housing at the second end;
d) a sealed cavity formed by the housing, the top plate, and the bonnet when the top plate and the bonnet are secured to the housing;
e) a piston biased away from the bonnet; and
f) a stem secured to the piston, wherein the stem is axially actuated by motion of the piston, and further wherein the stem passes through the bonnet to be securable to an actuated component and the bonnet is securable to equipment comprising the actuated component; and
wherein the top plate or the bonnet can be unsecured from the housing without the stem being unsecured from the actuated component, and further wherein the housing can be reattached to the top plate or the bonnet with the first end and the second end transposed.
